(19) United States
(12) Patent Application Publication
(10) Pub. No.: US 2017/0113085 A1
(43) Pub. Date: Apr. 27, 2017

(54) TREATMENT METHOD FOR COAL FLY ASH

(71) Applicant: SOLVAY SA, Brussels (BE)

(72) Inventor: Rasik H. RAYTHATHA, Kingwood, TX (US)

(21) Appl. No.: 15/315,860

(22) PCT Filed: Jun. 3, 2015
(86) PCT No.: PCT/US15/33904

§ 371 Date: Dec. 2, 2016

Related U.S. Application Data
(60) Provisional application No. 62/007,923, filed on Jun. 4, 2014.

(51) Int. Cl. A62D 3/33; B01D 53/83; F23J 15/00; B01D 53/78; B09B 3/00; B01D 53/40; B01D 53/64

(52) U.S. Cl. CPC A62D 3/33; B01D 53/40; B01D 53/83; B01D 53/64; B01D 53/78; B09B 3/0041; F23J 15/003; B01D 2251/304; B01D 2251/404; B01D 2251/406; B01D 2257/2045; B01D 2257/2047; B01D 2257/302; B01D 2258/0283; A62D 2101/08

(57) ABSTRACT

A treatment method for coal fly ash, and in particular sodic fly ash, comprises 1) contacting the coal fly ash with anhydrite, and 2) contacting the coal fly ash in the presence of water with at least one additive. The material obtained from the contacting steps (1) and (2) may be dried. The steps (1) and (2) may be carried simultaneously or sequentially. The additive may comprise at least one component selected from the group consisting of strontium-containing compounds, barium-containing compounds, dolomite, a dolomite derivative such as calcined or hydrated dolomite, water-soluble sources of silicate such as sodium or potassium silicate, iron-containing compounds, and any combinations thereof. A particularly preferred additive comprises sodium silicate. The method may be effective in reducing the sodium content in the fly ash (Na₂O), reducing the alkalinity of the fly ash, and/or stabilizing at least one heavy metal such as selenium and/or arsenic to reduce their leachability.

### CROSS-REFERENCE TO RELATED APPLICATIONS

The present application claims priority to U.S. Provisional Application No. 62/007,923 filed Jun. 4, 2014, the whole content of this application being incorporated herein by reference for all purposes.

### TECHNICAL FIELD OF THE INVENTION

This invention relates to the treatment of coal fly ash, and in particular the treatment of sodic fly ash which is provided in a combustion process utilizing a sodium-based sorbent pollution control system, particularly utilizing a dry sorbent comprising sodium carbonate, sodium bicarbonate, and/or sodium sesquicarbonate (or trona) in a coal combustion process for power generation.

### BACKGROUND OF THE INVENTION

Emissions regulations in the United States have resulted in changes to coal-based electric generating plants through the addition of emission controls.

During combustion of coal in coal-fired systems, combustion products/byproducts are generated and entrained in exhaust gases, sometimes referred to flue gases. These combustion byproducts include fly ash comprising lightweight particulate matter; and gaseous compounds such as sulfur dioxide (SO₂), sulfur trioxide (SO₃), hydrochloric acid (HCl), and hydrofluoric acid (HF). These gaseous combustion byproducts may become air pollutants if emitted to the atmosphere. Control of SO₂/SO₃ emissions (commonly referred to as ‘SOx’ emissions) and HCl/HF emissions requires removal of these gaseous compounds from flue gases prior to release of the flue gases into the environment. Many materials have been employed to treat the flue gases. The physical nature of these materials varies from wet scrubbing to injection of dry powdered materials and is dependent upon the overall pollution control process system employed.

The gaseous combustion byproducts are generally acidic, and thus slurries or dry materials used to remove (“scrub”) them from the flue gases are alkaline. Wet removal systems (referred to as ‘scrubbers’) used for flue gas desulfurization typically utilize aqueous slurries of lime-based reagents (e.g., calcium oxide) or limestone to neutralize the sulfurous and/or sulfuric acids produced from the dissolution and subsequent oxidation of flue gas in scrubbers. The reaction taking place in wet scrubbing of SO₂ using a CaCO₃ (limestone) slurry or a lime-based slurry (Ca(OH)₂) produces CaSO₃ (calcium sulfite).

When using wet scrubbers employing limestone slurries or lime-based reagents, large volumes of waste product are produced and must be hauled away for disposal. Such practice is common among power plants located in areas where landfill space is abundant or is a cost-effective disposal alternative.

Recently, other alkali materials have gain acceptance in lieu of or in addition of lime-based reagents and limestone which offer flexibility and versatility in the operation of emission controls, maintenance and waste disposal requirements of flue gas desulfurization scrubber systems. These other materials are typically more expensive, but also more efficient, than lime and limestone and are more often used:

1. where the volume of waste gas to be treated is small (compared to those from large power plants);
2. where other factors such as transportation cost of the alkali material is economical;
3. where required or necessitated by local or regional regulatory constraints; or
4. where any combination of these and other economic, technical, or regulatory issues make this alternative economically and environmentally viable.

Some of these alternative alkali materials used in flue gas treatment are dry sodium-based sorbents which include sodium carbonate (Na₂CO₃), sodium bicarbonate (NaHCO₃), sodium sesquicarbonate (Na₂CO₃.NaHCO₃.2H₂O), combinations thereof, or minerals containing them such as trona, nahcolite.

Trona, sometimes referred to as sodium sesquicarbonate (Na₂CO₃.NaHCO₃.2H₂O) due to its high content in sodium sesquicarbonate (typically 70-99 wt %), is a natural mineral and is receiving increased widespread use in dry flue gas treatment systems. Nahcolite, sometimes referred to as sodium bicarbonate (NaHCO₃), is also a natural mineral which may be used in dry or slurry flue gas treatment systems.

For dry sorbent injection, dry powdered sodium-containing sorbent (such as particulate trona or sodium bicarbonate) is injected into an air duct through which a flue gas stream (containing combustion solid matter and gaseous acidic combustion byproducts) flows. The acidic gases and the sodium-containing sorbent (e.g., trona or sodium bicarbonate) react to form treatment byproducts. The solid components of the treated flue gas including combustion solid matter, treatment by-products (which may be solid sodium salts and/or may be adsorbed/absorbed on the combustion solid matter), and optionally any unreacted sodium-containing sorbent (when a stoichiometric excess is used) are removed from the flue gas stream using a particulate recovery system such as one or more baghouse filters or preferably one or more electrostatic precipitators (ESP) to collect solids referred to as a ‘sodic fly ash’ and to recover a DSI-treated flue gas stream which may be further subjected to a wet scrubber to further remove remaining acid gaseous combustion byproducts.

One example of a flue gas desulfurization treatment using a sodium-based dry sorbent injection technology is described in U.S. Pat. No. 7,854,911 by Maziuk. Maziuk describes the chemical reaction of trona with SO₂, which unlike sodium bicarbonate, melts at elevated temperatures. According to Maziuk, trona (mainly sodium sesquicarbonate) undergoes rapid calcination of contained sodium bicarbonate to sodium carbonate when heated at or above 275° F. Maziuk suggests that the “popcorn like” decomposition creates a large and reactive surface by bringing unreacted sodium carbonate to the particle surface for SO₂ neutralization. The byproduct of the reaction is sodium sulfate and is collected in the fly ash. The chemical reaction of the trona with the SO₂ is represented below:

2[Na₂CO₃.NaHCO₃.2H₂O]→3Na₂CO₃+5H₂O+CO₂

Na₂CO₃+SO₂→Na₂SO₃+CO₂

Na₂SO₃+½O₂→Na₂SO₄

Other reactions with trona when injected into flue gas of a coal-fired power plant, may include a reaction with hydrochloric acid according to the following:

[Na₂CO₃.NaHCO₃.2H₂O]+3HCl→3NaCl+4H₂O+2CO₂

The solid reaction products of the trona and the acid gases (e.g., SO₂, SO₃, HF, HCl) which are primarily sodium salts (e.g., sodium sulfate, sodium sulfite, sodium fluoride, and/or sodium chloride) as well as unreacted sodium carbonate are then collected in one or more particulate collection devices, such as baghouse filter(s) or electrostatic precipitator(s).

For example, trona may be maintained in contact with the flue gas for a time sufficient to react a portion of the trona with a portion of the SO₃ to reduce the concentration of the SO₃ in the flue gas stream. For SO₃ removal, the total desulfurization is preferably at least about 70%, more preferably at least about 80%, and most preferably at least about 90%.

Whenever possible, fly ash resulting from the combustion of coal (‘coal fly ash’) which is collected from the particulate recovery system may be used in various applications; otherwise dry fly ash is disposed into a landfill.

In 2006, U.S. coal-fired power plants have generated 72 million tons of fly ashes. Almost 45% of these solid residues (32 million tons) are used in a dozen of applications. According to AMERICAN COAL ASH ASSOCIATION, “2006 Coal Combustion Product (CCP)—Production and Use Survey”, among these applications,
15 million tons of fly ashes are used in concrete/concrete products/grout;
7 million tons of fly ashes are used in structural fills/embankments; and
4 million tons of fly ashes are used in cement/raw feed for clinker.

Sodic fly ashes resulting from flue gas acid gas removal treatment which predominately use powdered trona or sodium bicarbonate as sodium-based sorbent in dry sorbent injection (DSI) technology systems contain not only fly ash particles coated and intermixed with water-soluble sodium salts (e.g., sodium sulfite, sulfate, chloride, and/or fluoride) and unreacted sodium-based sorbent, but also contain various metallic compounds and other chemical attributes that may pose an environmental concern if the sodic fly ashes are placed in a landfill or used for beneficial re-use.

Even though trona or sodium bicarbonate use for acid gas removal from flue gases of coal-fired power plants has been helpful to address regulatory constraints in the United States, these sodium-based sorbents have modified the physical and chemical characteristics of the fly ashes with two consequences which are as follows:
the leaching of trace elements (such as Se, As, Mo) and soluble matter increases with sodium content and alkalinity: it raises the question of its impact on the environment (environmental storage management, surface and ground water quality, human health . . . ), and
the high content of water-soluble sodium salts may certainly prevent from the possible valorization of the sodic fly ashes into concrete if done without any further treatment (Standard ASTM-C-618: as a pozzolanic additive, fly ash must not content more than 1.5 wt % of Na₂O) and also raises the issue of its storage.

Resulting from the introduction of the sodium-based sorbent, some water-soluble sodium-heavy metal complexes, compounds, and the like, may be formed, when heavy metals contained in the flue gas get in contact with the sodium-based sorbent. As the formation of water-soluble matter with fly ash trace elements (such as Se) increases with sodium content and alkalinity, so does the leachability of some of these trace elements from the sodic fly ash.

In an Electric Power Research Institute Report No. 1017577 (2010) entitled “Impacts of Sodium-based Reagents on Coal Combustion Product Characteristics and Performance”, it was reported that greater than 50% of the sodium leached in all leachates from the sodium-based reagent coal combustion product samples (CCP) while less than 15% of the sodium leached from standard CCP samples. This indicates that the added sodium was more mobile than the inherent sodium from the coal in the standard CCPs. It was also remarked that selenium and arsenic were generally more mobile in the leachates from CCP samples with sodium-based sorbent injection than in the standard CCP samples. It was noted that the highest vanadium leachate concentrations in the sample set were from the CCP sample with sodium carbonate injection.

Jianmin Wang and coworkers also studied the impact of trona injection on the characteristic of the resulting fly ash and on the leaching characteristics of anionic elements, including As, Se, Mo, and V.

In Su et al., “Impact of Trona-Based SO₂ Control on the Elemental Leaching Behavior of Fly Ash” Energy Fuels, 2011, Vol. 25, pg. 3514-3521, and in Dan et al, “Increased Leaching of As, Se, Mo, and V from High Calcium Coal Ash Containing Trona Reaction Products” Energy Fuels, 2013, vol. 27, pg. 1531-1537, it was shown that trona injection and subsequent capture of the reaction products with fly ash significantly enhanced the leaching of As, Se, Mo, and V. Their results also indicated that, with trona addition, the distribution of these anions shifted to the soluble trona fraction of the ash. Therefore, the dissolution of the spent trona sorbent resulted in more leaching of these anionic elements. In addition, they found that trona injection significantly reduced the adsorption capability of the insoluble fraction of the ash for As, Se, and V under the natural pH, and made them more leachable. For use in cement and concrete applications, a number of strategies have been developed over the last 50 or more years for effectively designing concrete with pozzolans such as coal fly ash. A pozzolan is broadly defined as an amorphous or glassy silicate or aluminosilicate material that reacts with calcium hydroxide formed during the hydration of Portland cement in concrete to create additional cementitious material in the form of calcium silicate and calcium silicoaluminate hydrates. However it has been established that pozzolans must be low in alkalis (Na₂O and K₂O), to avoid long-term durability problems in concrete by expansion due to alkali-silica reactions.

If the valorization (such as use in cement and concrete) or landfilling of a sodic fly ash may be problematic due to high sodium content and leachability of some heavy metals result in exceeding the maximum allowed content limits in leachates set by local, state and/or federal regulations for leaching, the sodic fly ash may need to be processed to satisfy these requirements for valorization or landfill.

At an industrial scale, a wet treatment of sodic fly ash would include solubilization of water-soluble components from the sodic fly ash (which are mostly spent sorbent with unreacted sorbent and pollutants' reaction by-products), a liquid/solid separation and a subsequent treatment of leachates with high levels of Na, sulfate, carbonate, hydroxide, and some heavy metals (particularly selenium, arsenic and molybdenum). But this approach displaces the fly ash disposal issue to a wastewater management issue.

In particular, if the leachate in an untreated trona-based fly ash provided by coal combustion may generate a leachate with a content in selenium (Se) or arsenic (As) above the regulatory limits, such sodic coal fly ash must be treated prior to land disposal or beneficial re-use.

The Resources Conservation and Recovery Act (RCRA) of 1976 is the principal federal law in the United States governing the disposal of solid waste and hazardous waste. The maximum acceptable leachate concentration for selenium into a RCRA Subtitle D landfill is one (1) mg/L; and the maximum acceptable leachate concentration for arsenic into a RCRA Subtitle D landfill is five (5) mg/L.

Selenium in particular is a difficult metal to treat because selenium (Se) exhibits a variety of oxidation states. In an alkaline environment under slightly oxidizing conditions, the selenate (Se⁺⁴, SeO₄⁻²) ion predominates. Conversely, in an acidic environment that is still oxidizing, the selenite (Se⁺³, SeO₃) ion predominates. Selenate is significantly mobile in soils with little adsorption of the selenate ion over a pH range of 5.5-9.0. Therefore, selenium mobility is favored in oxidizing environments under alkaline conditions. As a result, the concentration and form of selenium is governed by pH, redox, and matrix composition (e.g., soil, ash) and makes short term and long term treatment difficult in various environments, but particularly difficult for sodic fly ash at elevated pH when excess sodium-based sorbent such as trona (Na₂CO₃.NaHCO₃.2H₂O) is used in flue gas treatment. Reported pH for sodic fly ashes has been from about 10.5 to about 12.8.

Water-soluble heavy metal compounds (such as selenate and/or selenite) may be detrimental if they leach from the fly ash.

Hence here lies a dilemma for the power plant operators. On one side, one needs to reduce the amounts of gaseous pollutants emitted by combustion processes (such as coal-fired power plants), while due to the nature of the fuel necessitating chemical treatments for pollutant control, there is an increased generation of combustion wastes containing heavy metals such as Se and As and resulting in an increase need in disposal or valorization of solid wastes obtained therefrom.

Additionally, if in order to address the increased leachability of some heavy metals (mostly oxyanions) from sodic fly ash, the wet processing approach is likely avoided since it results in dissolving the water-soluble components of fly ash (mostly spent sodium-based sorbent, reaction byproducts, and leachable heavy metals) and then in treating the resulting wastewater. One might have to envision a dry processing approach for stabilization of sodic fly ash. However, the handling of such dry material poses additional concern relating to fugitive dust. Dust control thus may need to be addressed and may become an integral part of such a treatment method.

### SUMMARY OF THE INVENTION

The present invention relates to a method for treating a coal fly ash which is provided by a combustion process in which a dry sorbent comes in contact with a flue gas generated by combustion to remove at least a portion of pollutants contained in the flue gas. The present treatment method aims to reduce the sodium content in the fly ash (Na₂O), to adjust the alkalinity of fly ash and/or to stabilize heavy metal(s) such as selenium and/or arsenic to reduce their leachability.

Such method is particularly useful for treating a fly ash generated in a coal-fired power plant using a dry sodium-based sorbent.

In particular embodiments, the present invention relates to the treatment of a coal fly ash generated in a coal-fired power plant in which a dry sorbent is injected into a flue gas generated by combustion of coal in order to remove at least a portion of pollutants contained in the flue gas. The sorbent used for pollutants removal from the flue gas preferably comprises a sodium-containing sorbent, whereby the fly ash is a sodic fly ash which contains at least one sodium compound.

A particular aspect of the present invention relates to a treatment method for coal fly ash, comprising:

(1) contacting such coal fly ash with anhydrite; and
(2) contacting, in the presence of water, such coal fly ash with at least one additive.

The method may be effective in reducing the sodium content in the fly ash (Na2O), reducing the alkalinity of the fly ash, and/or stabilizing at least one heavy metal such as selenium and/or arsenic present in the fly ash to reduce their leachability.

The method may further comprise: (3) drying the material obtained from the contacting steps (1) and (2) to form a dried matter.

The method may further comprise: washing the material obtained from the contacting steps (1) and (2) to form a washed matter.

The coal fly ash is preferably a sodic fly ash with a Na content greater than 1.5 wt % expressed as Na₂O, preferably greater than 2 wt % expressed as Na₂O and/or has a Na content of less than 50 wt % expressed as Na₂O, preferably less than 45 wt % expressed as Na₂O.

In some embodiments, the at least one additive comprises a strontium-containing compound; a barium-containing compound; dolomite; one or more dolomite derivatives (such as dolomitic lime, selectively calcined dolomite, and/or hydrated dolomite); an iron-containing compound (such as ferric sulfate, ferric chloride); a water-soluble source of silicate; or any combinations of two or more thereof.

In preferred embodiments, the at least one additive comprises a water-soluble source of silicate. The at least one water-soluble source of silicate comprises sodium silicate, potassium silicate, or any combination thereof. In such instance, the at least one additive may optionally comprise another component selected from the group consisting of a strontium-containing compound; a barium-containing compound; dolomite; one or more dolomite derivatives (such as dolomitic lime, selectively calcined dolomite, and/or hydrated dolomite); an iron-containing compound (such as ferric sulfate, ferric chloride); and any combinations of two or more thereof.

The at least one additive comprising comprises a water-soluble source of silicate may further comprise at least one component selected from the group consisting of strontium hydroxide, strontium chloride, dolomite, dolomitic lime, ferric sulfate, ferric chloride, and any combinations of two or more thereof.

The contacting steps (1) and (2) may be carried out simultaneously.

The contacting step (1) may be carried out before the contacting step (2). The contacting in step (2) preferably comprises applying the additive and the water onto the contacted material obtained in step (1).

The contacting in step (1) preferably comprises dry mixing the anhydrite with said coal fly ash.

The method may further comprise: before performing step (2), dispersing or dissolving or diluting the at least one additive into water or an acidic solution to form an aqueous suspension, slurry or solution containing the at least one additive and then carrying out the contacting of said coal fly ash with said resulting aqueous dispersion, slurry, or solution in step (2).

The contacting in step (2) may comprise mixing said coal fly ash and an aqueous solution or slurry or suspension containing the at least one additive with optionally additional water or an acidic solution.

The contacting in step (2) may comprise spraying or misting an aqueous solution containing the at least one additive onto said coal fly ash. The spraying or misting preferably reduces dusting of coal fly ash.

The method may further comprise: before performing step (2), first dry mixing the at least one additive in solid form and said coal fly ash to form a dry blend, wherein the contacting in step (2) comprises adding water or an acidic solution to said dry blend.

The contacting in step (2) may use a water content so as to form a paste comprising the at least one additive and said sodic fly ash. The paste may contain at most 40 wt % water, preferably may contain between 1 wt % and 35 wt % water.

The contacting in step (2) may be carried out under an acidic pH of from 3 to 7 or under near-neutral pH of from 6 to 8.

The coal fly ash is characterized by a liquid holding capacity, and the amount of water used during contacting in step (2) is from about 1 wt % to a value within +1-5 wt % of said liquid holding capacity of the coal fly ash.

The method may further comprise:

(3) drying the material obtained after both contacting steps (1) and (2) at a temperature equal to or more than 100° C.

The drying in step (3) is preferably carried out without calcining or sintering the material obtained after both contacting steps (1) and (2).

When the coal fly ash comprises a heavy metal to be stabilized, the method preferably reduces the leachability of such heavy metal by at least 50% in the treated coal fly ash. The heavy metal to be stabilized is selected from the group consisting of selenium, arsenic, and combination thereof.

When the additive comprises sodium silicate, the method may comprise: diluting a concentrated sodium silicate solution optionally further comprising another additive component with water or an acidic aqueous medium to form a diluted solution, and then spraying or misting the resulting diluted solution onto a mass of said coal fly ash for an effective contact between sodium silicate and said fly ash. The spraying or misting may be carried out on the mass of coal fly ash while in motion or on the mass of said coal fly ash which is motionless.

In some additional or alternate embodiments, when the contacting step (2) is carried out with an additive comprising a water-soluble source of silicate, the method may further comprise: (2′) contacting the fly ash before step (2) or the material resulting from step (2) with a second additive selected from the group consisting of strontium-containing compounds; barium-containing compounds; dolomite; one or more dolomite derivatives (like dolomitic lime, selectively calcined dolomite, and/or hydrated dolomite); iron-containing compounds (such as ferric sulfate, ferric chloride); and any combinations of two or more thereof.

In preferred embodiments, the fly ash is preferably a sodic coal fly ash provided by a coal combustion process in which a dry sodium-containing sorbent is injected into the flue gas generated by coal combustion to remove at least a portion of pollutants (preferably acid gases, such as SOx, HCl, HF) contained in the flue gas.

In the embodiment of such method in which an optional additive component is used either in step (2) or optionally in a separate step (2′), the optional additive component preferably comprises at least one strontium-containing compound, dolomite, a dolomite derivative (such as dolomitic lime, hydrated dolomite), another water-soluble source of silicate different than that used in step (2); an iron-containing compound (such as ferric sulfate, ferric chloride); or any combinations of two or more thereof.

The contacting in step (2) may comprise mixing the fly ash and an aqueous solution or slurry or suspension comprising the at least one additive with optionally additional water or an acidic solution; may comprise mixing water or an acidic solution with a dry blend comprising the at least one additive in solid form and the fly ash; and/or may comprise spraying an aqueous solution or slurry or suspension containing the at least one additive onto said fly ash with optionally additional water or an acidic solution. Misting an aqueous solution may be used instead or in addition of spraying.

The method may comprise, before performing step (2), first dispersing, dissolving, or diluting the at least one additive into water or an acidic solution to form an aqueous suspension, slurry or solution containing the at least one additive before contacting, when contacting comprises mixing the resulting aqueous dispersion, slurry, or solution and said fly ash and/or spraying the resulting aqueous dispersion, slurry, or solution onto said fly ash. Misting may be used instead or in addition of spraying for an aqueous solution.

The method may comprise, before performing step (2), first dry mixing the at least one additive in solid form and the fly ash to form a dry blend before contacting, wherein contacting in step (2) comprises mixing water or an aqueous medium (e.g., acidic solution) with such dry blend.

In the present invention, the additive comprising sodium silicate preferably comprises, or consists of, a solution containing sodium silicate.

Step (2) may comprise contacting the fly ash with sodium silicate with a sodium silicate content (based on the total weight of fly ash+sodium silicate+water) of at least 0.5 wt %, or of at least 0.8 wt %; or of at least 1 wt %; or more than 1 wt %. The sodium silicate content (based on the total weight of fly ash+sodium silicate+water) may be up to 10 wt %, preferably to 8 wt %, more preferably up to 6 wt %; yet more preferably with a sodium silicate content up to 5 wt %.

When the additive comprises a solution containing sodium silicate, step (2) may comprise contacting the fly ash with a solution containing sodium silicate with a sodium silicate content of from 0.5 wt % up to 40 wt %, preferably a solution with a sodium silicate content of from 1 wt % up to 10 wt %, more preferably a solution with a sodium silicate content of from 1.5 wt % up to 6 wt %; more preferably a solution with a sodium silicate content of from 2 wt % up to 5 wt %.

Since commercially available silicate solutions may have a high silicate content (such as for example from about 30 to about 40 wt % for sodium silicate solution), the purchased source of silicate may be diluted with water or an acidic solution prior to contact with the fly ash. Dilution should allow more homogeneous distribution of the water-soluble source of silicate onto the fly ash and should provide more uniform contact between this additive and the fly ash by more evenly coating the fly ash with the diluted silicate source.

A further aspect of the present invention thus provides a method for increasing the dry bulk density of a fly ash while minimizing water usage to control fly ash dusting. This method preferably comprises: carrying out step (2) for contacting a fly ash with a water-soluble source of silicate.

In this particular aspect, the method may include dispersing an additive comprising sodium silicate onto a mass of fly ash. When the source of sodium silicate is a concentrated sodium silicate solution (e.g., from 30 to 40 wt % sodium silicate), the method may include dilution of such concentrated sodium silicate solution with water or acidic aqueous medium and then applying the resulting diluted solution onto a mass of fly ash for an effective contacting between sodium silicate and fly ash. The contacting step (2) preferably includes a spraying and/or misting technique. Spraying and/or misting may be carried out on a mass of fly ash while in motion such as on a conveyor belt. Spraying or misting may be carried out on a motionless mass of fly ash, such as a heap or a pile or a spread on a liner. Spraying and/or misting may be carried out with the help of nozzles to provide fine liquid droplets. Nozzle sizes, shapes, patterns and liquid flow rate can be varied to suit specific dust particle sizes and operating conditions.

The spraying and/or misting of the additive containing the silicate source (in form of a solution) not only permits uniform distribution of silicate on top of the fly ash (thereby evenly coating the fly ash particles with this additive) to effect good contact for stabilization of at least some of the heavy metals contained in the fly ash, and also controls dusting of the fly ash.

The addition of a water-soluble source of silicate to a fly ash thus may provide at least one of the following advantages:
reducing the leachability of heavy metals (particularly Se and/or As) from the treated fly ash, in particular when the coal fly ash is a sodic fly ash;
controlling fly ash dusting, especially when the additive in a solution form is sprayed or misted onto a mass of coal fly ash;
reducing the optimal moisture content of the coal fly ash; and/or
increasing the dry density of the coal fly ash (resulting in less weight to dispose of in landfills).

The foregoing paragraphs have been provided by way of general introduction, and are not intended to limit the scope of the following claims. The presently preferred embodiments, together with further advantages, will be best understood by reference to the following detailed description.

### DETAILED DESCRIPTION OF THE PREFERRED EMBODIMENTS

### Definitions

The terms “heavy metals” as used herein, refer generally to elements including, for example, arsenic, selenium, antimony, beryllium, barium, cadmium, chromium, lead, nickel and zinc. As used herein, these terms encompass the elemental form of these metals as well as organic and inorganic compounds and salts containing them. Many of these elements and compounds thereof are harmful to human, animal and/or aquatic life.

The term “solubility” refers to the water solubility of a compound in water or an aqueous solution, unless explicitly stated otherwise.

As used herein, the term ‘anhydrite’ refers to anhydrous calcium sulfate (CaSO₄).

As used herein, the term ‘additive’ refers to a chemical additive.

As used herein, the term “trona” includes any source of sodium sesquicarbonate.

The term “flue gas” includes the exhaust gas from any sort of combustion process (including combustion of coal, oil, natural gas, etc.).

As used herein, the term “pollutants” in a flue gas includes acid gases such as SO₂, SO₃ (altogether typically termed SOx), HCl, HF, and NOₓ and some heavy metal-containing compounds which may be in a vaporized form.

As used herein, the term “sorbent” refers to a material which upon contact with a flue gas interacts with some of the flue gas constituents (such as pollutants) so as to remove at least some of them from the flue gas. Such interaction may include sorption of at least one flue gas constituent into or onto the sorbent and/or reaction between the sorbent and at least one flue gas constituent.

As used herein, the term ‘spent sorbent’ generally refers to the reaction mixture which is obtained in a dry sodium-based injection and which is collected in the fly ash material. The spent sorbent contains reaction products and byproducts (such as highly water-soluble sodium sulfate, sodium sulfite, sometimes sodium bisulfate), and also unconverted dry sorbent (such as sodium bicarbonate and/or sodium carbonate).

The term ‘comprising’ includes ‘consisting essentially of’ and also “consisting of”.

A plurality of elements includes two or more elements.

The phrase ‘A and/or B’ refers to the following selections: element A; or element B; or combination of elements A and B (A+B).

The phrase ‘A1, A2, . . . and/or An’ with n≧3 refers to the following choices: any single element Ai (i=1, 2, . . . n); or any sub-combinations of from two to (n−1) elements chosen from A1, A2, . . . , An; or combination of all elements Ai (i=1, 2, . . . n). For example, the phrase ‘A1, A2, and/or A3’ refers to the following choices: A1; A2; A3; A1+A2; A1+A3; A2+A3; or A1+A2+A3.

In the present Application, where an element or component is said to be included in and/or selected from a list of recited elements or components, it should be understood that in related embodiments explicitly contemplated here, the element or component can also be any one of the individual recited elements or components, or can also be selected from a group consisting of any two or more of the explicitly listed elements or components. Any element or component recited in a list of elements or components may be omitted from such list. Further, it should be understood that elements and/or features of processes or methods described herein can be combined in a variety of ways without departing from the scope and disclosure of the present teaching, whether explicit or implicit herein.

The use of the singular ‘a’ or ‘one’ herein includes the plural (and vice versa) unless specifically stated otherwise.

In addition, if the term “about” or “ca.” is used before a quantitative value, the present teachings also include the specific quantitative value itself, unless specifically stated otherwise. As used herein, the term “about” or “ca.” refers to a +−10% variation from the nominal value unless specifically stated otherwise.

### Fly Ash

The fly ash which is treated in the method according to the present invention is preferably generated from a power plant, such as a coal-fired power plant. Such power plant preferably comprises one or more pollutants control processes and systems which by the use of sorbent(s) allow the removal of some pollutants from an exhaust gas (flue gas stream) generated from such power plant to meet regulatory requirements for gas emissions.

When a sorbent used in a pollutants control process is sodium-based, the fly ash may be called a ‘sodic’ fly ash, particularly if the sodium content of the fly ash is greater than 1.5 wt % expressed as Na₂O. The pollutants in the flue gas generally include acid gases such as SO₂, SO₃, HCl, and/or HF. The pollutants in the flue gas may further include one or more heavy metals. The pollutants to be removed by the use of sorbent(s) are preferably SO₂ and/or SO₃; HCl; and optionally heavy metals such as mercury.

The fly ash is preferably generated by a coal-fired power plant employing at least one dry sorbent injection (DSI) technology in which at least one dry sorbent comprises or consists of one or more sodium-containing sorbents. In such process, the resulting coal fly ash contains one or more water-soluble sodium-containing compounds, such as sodium carbonate and/or sodium sulfate, and hence is preferably a ‘sodic’ coal fly ash. The sodium-containing sorbent which is used in the DSI technology to generate the sodic coal fly ash may be selected from the group consisting of sodium carbonate (Na₂CO₃), sodium bicarbonate (NaHCO₃), sodium sesquicarbonate (Na₂CO₃.NaHCO₃.2H₂O), sodium sulfite (Na₂SO₃), and any combinations thereof. Minerals containing one or combinations of these sodium compounds (such as trona, nahcolite) may be used instead of the compounds themselves.

A ‘sodic’ fly ash which is to be treated with steps (1) and (2) of the present invention comprises at least one sodium compound. The at least one sodium compound in the sodic fly ash to be treated may be selected from the group consisting of sodium carbonate, sodium sulfate, sodium sulfite, sodium bisulfate, sodium bisulfate, sodium chloride, sodium fluoride, one or more sodium compounds comprising at least one heavy metal to be stabilized by the present method (such as selenium and/or arsenic), and combinations thereof. The main water-soluble sodium components of the sodic fly ash before treatment are generally sodium carbonate, sodium sulfate, and/or sodium chloride. The sodic fly ash before the contacting step preferably contains at least one sodium compound selected from the group consisting of sodium carbonate, sodium sulfate, sodium sulfite, sodium chloride, sodium fluoride, one or more sodium compounds containing selenium and/or arsenic, and combinations thereof.

The sodic fly ash before treatment may have a Na content greater than 1.5 wt % expressed as Na₂O, preferably equal to or greater than 2 wt % expressed as Na₂O. The sodic fly ash may have a Na content less than 50 wt % expressed as Na₂O, preferably equal to or less than 45 wt % expressed as Na₂O.

In some embodiment, the sodic fly ash before treatment contains selenium in an amount of at least 1 ppm or at least 2 ppm. The Se content in the sodic fly ash may be from 1 ppm up to 100 ppm, or may be from 2 ppm up to 30 ppm.

In some embodiment, the sodic fly ash before treatment contains arsenic in an amount of at least 2 ppm. The As content in the sodic fly ash may be from 2 ppm up to 200 ppm.

At least a portion of selenium and/or arsenic contained in the sodic fly ash before treatment (e.g., more than 1 ppm Se) is leachable in deionized water or in dilute acidic solution if no treatment with the additive in step (2) according to the present invention is carried out on the sodic fly ash.

In some embodiment, the sodic fly ash before treatment further comprises water-insoluble material comprising silicon and/or aluminum. The main water-insoluble components of the sodic fly ash may comprise silicon, aluminum, iron, and calcium measured as oxides.

A sodic fly ash may have a pH from about 10 to about 13, preferably a pH from about 10.5 to about 12.8.

### Generating Fly Ash

Some embodiments of the present invention may further include a step of generating the fly ash in a process for treating a gas containing acid gas pollutants, such as preferably SOₓ, HCl, and/or HF.

The fly ash is preferably generated by a coal-fired power plant employing at least one dry sorbent injection (DSI) technology in which at least one dry sorbent comprises or consists of one or more sodium-containing sorbents.

For generating a sodic fly ash, a sodium-containing sorbent (e.g., trona or sodium bicarbonate) may be injected into a flue gas stream (e.g., generated in a coal-fired power plant), and the sodium-containing sorbent interacts with at least one of the pollutants to remove at least a portion of said pollutant(s). The injection is preferably taking place in a duct inside which the flue gas stream flows. In this process, it is recommended that the temperature of the flue gas stream is above 100° C., preferably above 110° C., more preferably above 120° C., most preferably above 130° C. At those temperatures, trona or sodium bicarbonate (or nahcolite) quickly decomposes into sodium carbonate having a high specific surface and thus high reactivity. The decomposition of these sodium-containing sorbents occurs within seconds upon exposure to such temperature, for example in the duct. The sorbent may be injected in the dry or semidry state. By ‘semidry state injection’ is understood to mean an injection of fine droplets of a water solution or preferably suspension of the sorbent (slurry) into a hot flue gas, having a temperature above 100° C. The solution or suspension evaporates immediately after its contact with the hot flue gas. The flue gas solids comprising products of the sorbent/pollutants interaction(s)—such as sorption and/or reaction(s)—can be recovered from the treated flue gas by one or more bag filters and/or one or more electrostatic precipitators to generate the sodic fly ash, a portion of which can be treated by the present method.

A suitable example for the use of sodium bicarbonate sorbent in the purification of a gas containing hydrogen chloride (such as flue gas from the incineration of household waste) may be found in U.S. Pat. No. 6,171,567 (by Fagiolini), incorporated herein by reference.

Another suitable example for the use of sodium bicarbonate in cleaning a gas containing sulfur dioxide and nitrogen monoxide (for example, fumes generated by the combustion of sulfur-containing fossil fuels, in electricity-producing power stations) may be found in U.S. Pat. No. 5,540,902 (by De Soete), incorporated herein by reference.

A suitable example for the use of trona sorbent in the purification of a gas containing sulfur dioxide may be found in U.S. Pat. No. 7,854,911 (by Maziuk), incorporated herein by reference.

A suitable example for the use of trona sorbent in the purification of a gas containing sulfur trioxide at a temperature from 500° F. to 850° F. may be found in U.S. Pat. No. 7,481,987 (by Maziuk), incorporated herein by reference.

Any of these pollutant control methods have the potential to generate a sodic fly ash which contains leachable heavy metals such as selenium and/or arsenic which may need to be treated according to the present invention to minimize Se leaching.

Step (1): Contacting with Anhydrite

The treatment method according to the present invention comprises: (1) contacting the coal fly ash with anhydrite.

The contacting in step (1) preferably comprises dry mixing the anhydrite with said coal fly ash.

Dry mixing (solid/solid mixing) may be carried out using a tumbling or convective mixer or any mechanical device in which a carrier liquid (e.g., water, organic solvent) is not required for mixing. A suitable tumbling mixer may be selected from the group consisting of a drum blender, a V-blender, a bin blender, and a double-cone blender. A suitable convective blender generally comprises a stationary vessel swept by a rotating impeller, and may be selected from the group consisting of a ribbon blender (a cylindrical vessel with a helical ribbon impeller mounted on a horizontal shaft), a paddle blender (a modified ribbon blender with paddles instead of a helical ribbon), a Nauta blender (a vertically oriented conical tank swept out by a rotating and processing screw impeller), a Forberg mixer (two paddle blender drives sweeping two connected troughs), a Z-blade blender (a cylindrical vessel swept out by a Z-shaped blade), and a Lodige mixer (similar to a kitchen mixer where plough-shaped shovels rotate a cylindrical drum). The dry mixing of the anhydrite in solid form and the coal fly ash is preferably carried out in a mixer selected from the group consisting of a ribbon blender and a V-blender.

When the anhydrite is in powder or particulate form prior to contact with the coal fly ash, its average particle size is generally less than 500 microns, preferably less than 250 microns, more preferably less than 150 microns. One of the advantages of a small particle size for anhydrite is that the anhydrite is more uniformly dispersed in the mass of coal fly ash. For this reason, the use of a particulate anhydrite with micron-sized particles would be preferred. An average particle size for anhydrite between about 0.5 micron and about 50 microns would be suitable.

The contacting in step (1) may alternatively comprise mixing the anhydrite with said coal fly ash in the presence of a liquid such as water or an aqueous medium. This mixing technique would be used for example when the contacting steps (1) and (2) are carried out simultaneously.

Contacting in step (1) may take place for a time period of no less than 10 minutes and/or of no more than 12 hours. Contact time between 10 minutes and 1 hour is generally suitable.

Contacting in step (1) may take place at a temperature of less than 100° C. A temperature greater than 0° C. and less than 100° C., or from 10° C. to about 70° C., preferably from 15° C. to about 50° C. would be suitable. A temperature between 4 and 45° C., more preferably between 10 and 30° C., would be preferred for this contacting step (1).

The amount of anhydrite used in the contacting step (1) should be at least 0.5 wt % based on the total weight of coal fly ash and anhydrite, or at least 1 wt %, or at least 2 wt %.

The amount of anhydrite used in the contacting step (1) should be at most 40 wt % based on the total weight of coal fly ash and anhydrite, or at most 30 wt %, or at most 25 wt %, or at most 20 wt %.

Contacting in step (1) should be effective in decreasing the sodium content of the material obtained after step (1).

Contacting in step (1) should be effective in decreasing the pH value of the material obtained after step (1) by at least 0.5 pH unit, or by at least 1 pH unit compared to the coal fly ash before contacting step (1).

Contacting in step (1) may be carried out by adding water. In such instances, the water content in the total mass of coal fly ash+anhydrite+water should be less than the holding capacity of the coal fly ash. Preferably, the water content in the total mass of coal fly ash+anhydrite+water should be less than 20 wt %, or less than 15%, or less than 10 wt %.

Contacting in step (1) is preferably carried out without adding water. In such instances, the water content in the total mass of coal fly ash+anhydrite should be less than 5 wt %.

The material obtained after the contacting in step (1) is preferably in a solid form or paste. More preferably, the material obtained after the contacting in step (1) is a free-flowing particulate material.

During contacting in step (1), it is preferred that no cementitious material (other than the one or more coal fly ashes) is used. That is to say, contacting in step (1) is preferably not carried out in the presence of Portland cement or of a calcium sulfoaluminate cementitious material.

Step (2): Contacting with at Least One Additive

The treatment method according to the present invention also comprises: (2) contacting, in the presence of water, the coal fly ash with at least one additive.

In some embodiments, the contacting steps (1) and (2) are carried out simultaneously.

In alternate embodiments, the contacting steps (1) and (2) are carried out sequentially.

In preferred embodiments, the contacting step (1) is carried out before the contacting step (2). In such instance, the contacting in step (2) comprises applying the additive onto the contacted material obtained in step (1).

Before performing step (2), the method may comprise: dispersing or dissolving or diluting the at least one additive into water or an acidic solution to form an aqueous suspension, slurry or solution containing the at least one additive and then carrying out the contacting of said coal fly ash with said resulting aqueous dispersion, slurry, or solution in step (2).

Before performing step (2), the method may comprise: first dry mixing the at least one additive in solid form and said coal fly ash to form a dry blend, wherein the contacting in step (2) comprises adding water or an acidic solution to said dry blend.

The contacting in step (2) may comprise mixing said coal fly ash and an aqueous solution or slurry or suspension containing the at least one additive.

The contacting in step (2) may comprise spraying or misting an aqueous solution containing the at least one additive onto said coal fly ash. Such spraying or misting may be carried out on the mass of fly ash while in motion or on the mass of fly ash which is motionless. The spraying or misting may further reduce dusting of the coal fly ash.

The at least one additive may comprise at least one component selected from the group consisting of strontium hydroxide, strontium chloride, dolomite, dolomitic lime, ferric sulfate, ferric chloride, a water-soluble source of silicate, and any combinations of two or more thereof.

In preferred embodiments, the at least one additive comprises at least one water-soluble source of silicate. In preferred embodiments, the at least one water-soluble source of silicate may comprise or consist of at least one water-soluble alkali earth metal-containing silicate compound. The alkali earth metal preferably is Na and/or K. The at least one additive may further comprise an optional component selected from the group consisting of at least one strontium-containing compound; at least one barium-containing compound; dolomite; one or more dolomite derivatives, like dolomitic lime, selectively calcined dolomite, and/or hydrated dolomite; at least one iron-containing compound (such as ferric sulfate, ferric chloride); or any combinations of two or more thereof.

A particular additive may comprise one or more sodium silicates and an optional additive component selected from the group consisting of at least one strontium-containing compound, dolomite, dolomitic lime, ferric sulfate, ferric chloride; and any combinations of two or more thereof.

In the present invention, the water-soluble source of silicate used in the additive or used as the sole additive preferably comprises at least one sodium silicate and/or at least one potassium silicate. More preferably, the water-soluble source of silicate comprises a sodium silicate.

A suitable source for sodium silicate may be crystalline sodium silicate in anhydrous or hydrate form. The molar SiO₂/Na₂O ratio may vary, but are typically from 0.5 to 2.0. A suitable source for crystalline sodium silicate may be sodium metasilicate (Na₂SiO₃) also called water glass or soluble glass with a molar SiO₂/Na₂O ratio of 1:1; sodium orthosilicate (Na₄SiO₄) with a molar SiO₂/Na₂O ratio of 0.5:1; sodium pyrosilicate or sesquisilicate (Na₆Si₂O₇) with a molar SiO₂/Na₂O ratio of 0.67; sodium disilicate (Na₂Si₂O₃) with a molar SiO₂/Na₂O ratio of 2:1; or mixtures thereof.

A suitable source for sodium silicate may be a sodium silicate solution. Sodium silicate solutions may have any weight SiO₂/Na₂O ratio, preferably a SiO₂/Na₂O weight ratio from 1.5 to 4. Commercially available sodium silica solutions have typically a SiO₂/Na₂O weight ratio from 1.6 to 3.25. Without wishing to be limited by any particular theory, since it is the silicate portion which is believed to impart the most stabilization for some of the heavy metals in the fly ash, it is desirable to use a high SiO₂/Na₂O weight ratio, such as a weight SiO₂/Na₂O ratio of from about 2.4 to about 3.22.

A suitable strontium-containing compound may comprise, or may consist of, strontium hydroxide, strontium chloride, strontium carbonate, or combinations of two or more thereof, preferably may comprise, or may consist, of strontium hydroxide and/or strontium chloride.

A suitable barium-containing compound may comprise, or may consist of, barium hydroxide and/or barium chloride.

A suitable additive for contacting with fly ash preferably does not include silica sand or silica fume.

A suitable additive component comprising Mg and/or Ca may comprise, or may consist of, magnesium carbonate (magnesite), dolomite, one or more dolomite derivatives, or any combinations of two or more thereof. It is preferred that the additive does not include lime. It is even more preferred that the additive does not consist of lime.

Dolomite is a mineral (CaCO₃.MgCO₃) which contains equimolar amounts of calcium carbonate and magnesium carbonate; it generally contains a minimum of 97% total carbonate composition.

A dolomite derivative is a compound which is obtained by the partial or complete conversion of at least one or both carbonate components of dolomite to an oxide or hydroxide form. Non-limiting examples of dolomite derivatives includes dolomitic lime (also known as ‘calcined dolomite’), selectively calcined dolomite, and/or hydrated calcined dolomite (also known as ‘hydrated dolomite’). Dolomitic lime is typically resulting from calcination of dolomite. Depending on the calcination conditions used, a ‘fully calcined dolomite’ or a ‘selectively calcined dolomite’ may be obtained. Dolomitic lime typically refers to the ‘fully calcined dolomite’ in which the calcination of dolomite at a temperature in the range of 900-1200° C. produces from both of its carbonate components the corresponding oxides and CO₂ to give formula: CaO.MgO. Since the magnesium carbonate component in the dolomite decomposes to the oxide form and CO₂ at a lower temperature (ca. 600° C.) than calcium carbonate (ca. 900° C.), dolomite can be selectively calcined (e.g., ≧600 and <900° C.) to convert its magnesium component to the oxide form while keeping most of the calcium component in carbonate form thereby providing a ‘selectively calcined dolomite’ with an approximate formula MgO.CaCO₃. Hydrated dolomite is a product of slaking fully calcined dolomite, whereby calcium oxide is hydrated while magnesium oxide remains intact; hydrated dolomite therefore has an approximate formula MgO.Ca(OH)₂. A pulverized dolomitic lime (of micron-sized particles), also called ‘DLP’, is particularly suitable as a source for additive.

A particularly suitable additive component containing Mg and Ca may comprise, or may consist of dolomite, dolomitic lime, hydrated dolomite, or any combinations of two or more thereof.

A particularly preferred additive component may comprise, or may consist of, at least one compound selected from the group consisting of strontium hydroxide, strontium chloride, dolomitic lime, ferric sulfate, ferric chloride, sodium silicate, and any combinations of two or more thereof.

A particularly advantageous additive to be used in step (2) comprises sodium silicate or a combination of sodium silicate with another additive component selected from the group consisting of strontium hydroxide, strontium chloride, dolomitic lime, ferric sulfate, ferric chloride, and any combinations thereof.

When the additive is in powder or particulate form prior to contact with the coal fly ash, its average particle size is generally less than 500 microns, preferably less than 250 microns, more preferably less than 150 microns. One of the advantages of a small particle size for a water-soluble additive is that the dissolution of such additive is faster in water. For this reason, the use of a particulate additive with submicron (e.g., nanosized) particles is also envisioned.

In some embodiments, the additive does not contain a phosphate-containing compound and/or a phosphoric acid-containing compound. In particular, the additive preferably does not contain orthophosphoric acid or any of its alkali metal/alkali earth metal salts.

In some additional or alternate embodiments, the additive does not contain a sulfide-containing compound, such as sodium sulfide Na₂S.

In some additional or alternate embodiments, the additive further contain an iron-containing compound, such as ferric chloride, ferric sulfate Fe₂(SO₄)₃.

In other embodiments, the additive does not contain an iron-containing compound, such as ferric chloride, ferric sulfate Fe₂(SO₄)₃.

In some additional or alternate embodiments, the additive does not contain sodium oxide (Na₂O), calcium chloride, and/or ammonium chloride.

In preferred embodiments, the additive excludes at least one compound selected from the group consisting of a phosphate-containing compound, a phosphoric acid-containing compound (including orthophosphoric acid or any of its alkali metal/alkali earth metal salts), a sulfide-containing compound, sodium oxide (Na₂O), calcium chloride, ammonium chloride, and an iron-containing compound, any subcombinations and combinations thereof.

In alternate embodiments, the additive contains an optional additive component selected from the group consisting of a phosphate-containing compound; a phosphoric acid-containing compound (including orthophosphoric acid or any of its alkali metal/alkali earth metal salts); a sulfide-containing compound; calcium chloride; ammonium chloride; and an iron-containing compound, such as ferric chloride, ferric sulfate Fe₂(SO₄)₃.

During contacting in step (2), it is preferred that no cementitious material (other than the one or more coal fly ashes) is used. That is to say, contacting in step (2) is preferably not carried out in the presence of Portland cement or of a calcium sulfoaluminate cementitious material. The additive preferably excludes Portland cement or/and a calcium sulfoaluminate cementitious material.

The content of the additive can vary over a wide range.

The amount of the additive is preferably sufficient to achieve at least a 50%, or at least 60%, or at least 75%, reduction in leachability of at least one heavy metal (such as Se and/or As) from the sodic fly ash.

The amount of the additive may be sufficient to achieve a reduction in leachability of at least one heavy metal (such as Se and/or As) from the treated material for the content of such heavy metal in the leachate not to exceed a maximum threshold value defined by local, state and/or federal environmental regulations. Leachability may be determined by leaching standards, such as European standard NF EN 12457-2 and American standard EPA 1311 from EPA Manual SW 486.

The amount of the additive may be sufficient to achieve a leachability of Se from the treated material of 1 ppm or less.

The content of the water-soluble source of silicate is usually higher than or equal to 0.1 percent based on the weight of the fly ash, preferably higher than or equal to 0.5 wt %, more preferably higher than or equal to 1 wt %, and most preferably higher than or equal to 2 wt %. The content of the water-soluble source of silicate is generally lower than or equal to 20 wt %, advantageously lower than or equal to 15 wt %, more advantageously lower than or equal to 10 wt %, and most advantageously lower than or equal to 5 wt %. A range from 2 wt % to 5 wt % for the water-soluble source of silicate is particularly advantageous. The amount of additive is based on the total weight of the fly ash including its water-soluble fraction.

The molar ratio of the water-soluble source of silicate in the additive to the one or more heavy metals which may be stabilized by carrying out the present method (such as selenium and/or arsenic) is typically higher than 1:1. The molar ratio of the water-soluble source of silicate in the additive to the one or more heavy metals to be stabilized may be at least 2:1, preferably from 2:1 to 100:1 or even more.

The contacting in step (2) takes place in the presence of at least some water. Contacting in step (2) does not include dry contact between the fly ash and any additive without presence of water. The sodic fly ash and at least one additive may be dry blended but in this instance, contacting is preferably initiated when water is added to the dry blend.

In some embodiments, the coal fly ash is characterized by a liquid holding capacity. The amount of water used during contacting in step (2) may be lower than the liquid holding capacity of said coal fly ash. In alternate embodiments, the amount of water used during contacting in step (2) may be equal to or higher than the liquid holding capacity of said coal fly ash but not exceeding 75%. The amount of water used during contacting in step (2) is preferably within +/−5 wt %, more preferably within +/−3 wt %, most preferably within +/−2 wt % of the liquid holding capacity of the coal fly ash.

In some embodiments, the water content used during contacting in step (2) is such that the material resulting from step (2) is a soft malleable paste. The paste may contain at most 50 wt % water or even at most 40 wt % water, preferably at most 35 wt % water, more preferably may contain between 1 wt % and 35 wt % water. Alternate embodiments may include a water content between 20 wt % and 35 wt % water, or between 30 wt % and 35 wt % water.

In some embodiments, the contacting step (2) is carried out under an acidic pH of from 3 to 7, or under near-neutral pH of from 6 to 8.

Since a water-soluble sodium compound such as sodium carbonate is typically present in a sodic fly ash, the sodic fly ash would have an alkaline pH (ca. 10-12); in such case, an acidic solution (e.g., a dilute HCl acidic solution) may be used instead of deionized water during the contacting step (2).

However the use of an acidic solution in step (2) may be unnecessary if the contacting step (1) is first carried out with an amount of anhydrite sufficient to lower the pH of the material obtained after contacting in step (1) by at least 0.5 pH unit, preferably by at least 1 pH unit. In such instance the contacting in step (2) is carried out on the material obtained after contacting in step (1).

Various techniques for achieving contact between the fly ash and the additive(s) may be used.

Mixing the additive(s) and the fly ash, such as, without being limiting, kneading, screw mixing, stirring, or any combinations thereof may be used for contacting. Such mixing may be carried out in the presence of water. Spraying or misting an additive onto a mass of fly ash may be an alternate or additional technique for contacting. Such spraying or misting may be carried out in the presence of a solution.

In some embodiments, the method may comprise before step (2), first dry mixing the at least one additive in solid form (such as powder or granules) and the coal fly ash to form a dry blend, and then adding water to such dry blend for initiating contacting.

In preferred embodiments, the method may comprise before step (2), first dry mixing the at least one additive in solid form (such as powder or granules) and the material obtained from step (1) to form a dry blend, and then adding water to such dry blend for initiating contacting with the additive.

Dry mixing (solid/solid mixing) may be carried out using a tumbling or convective mixer or any mechanical device in which a carrier liquid (e.g., water, organic solvent) is not required for mixing. A suitable tumbling mixer may be selected from the group consisting of a drum blender, a V-blender, a bin blender, and a double-cone blender. A suitable convective blender generally comprises a stationary vessel swept by a rotating impeller, and may be selected from the group consisting of a ribbon blender (a cylindrical vessel with a helical ribbon impeller mounted on a horizontal shaft), a paddle blender (a modified ribbon blender with paddles instead of a helical ribbon), a Nauta blender (a vertically oriented conical tank swept out by a rotating and processing screw impeller), a Forberg mixer (two paddle blender drives sweeping two connected troughs), a Z-blade blender (a cylindrical vessel swept out by a Z-shaped blade), and a Lodige mixer (similar to a kitchen mixer where plough-shaped shovels rotate a cylindrical drum). The dry mixing of the at least one additive in solid form and the sodic fly ash is preferably carried out in a mixer selected from the group consisting of a ribbon blender and a V-blender.

In embodiments wherein the method comprises forming a dry blend containing the additive(s) (in solid form) and the fly ash, the contacting step preferably comprises mixing water or an acidic solution with the dry blend. Such contacting step (2) involves wet mixing.

In preferred embodiments of the present invention, the method may comprise first dispersing or dissolving or diluting the additive(s) into water or in an acidic solution to form an aqueous suspension, slurry or solution containing the additive(s) and then carrying out step (2) by contacting the fly ash with the resulting aqueous dispersion, slurry, or solution comprising the at least one additive. This contacting step (2) may involve wet mixing, spraying, or combination of wet mixing and spraying. Misting an aqueous solution may be used instead of or in addition of spraying.

In embodiments when the method comprises forming an aqueous suspension, slurry or solution containing the additive(s), the contacting step (2) preferably comprises mixing the fly ash and the aqueous solution or slurry or suspension containing the additive(s) with optionally additional water or an aqueous medium (e.g., acidic solution). This contacting step (2) involves wet mixing.

Wet mixing (solid/liquid mixing) may be carried out using a mixer selected from the group consisting of a kneading mixer, a screw mixer, a cone mixer, a plow mixer, a ribbon blender, a pan Muller mixer, a stirring tank, a helical-blade mixer, an extruder (such as a Rietz, single-screw, or double-screw extruder), and any combinations thereof. Any mixer being suitable for paste mixing or viscous material mixing would be suitable for wet mixing according to such embodiment of the present invention.

In some additional or alternate embodiment wherein the method comprises forming an aqueous suspension, slurry or solution containing the additive(s), the contacting step may comprise spraying the aqueous solution or slurry or suspension containing the additive(s) onto the fly ash with optionally additional water or an aqueous medium (e.g., acidic solution).

The coal fly ash mass may be in motion during spraying or misting to allow even distribution of additives(s) onto the fly ash mass. For example, the mass of fly ash may be in motion on a moving surface (e.g., conveyor), in motion due to the rotation of a ribbon, screw or blade, or tumbling in a rotating vessel while the solution or suspension or slurry comprising one or more additives is sprayed onto the moving fly ash mass.

It is envisioned that more than one contacting technique may be employed during step (2) for contacting the fly ash (or the material obtained from step (1)) with the same additive or for contacting the fly ash (or the material obtained from step (1)) with different additives.

It is also envisioned that the same contacting technique may be employed for contacting the fly ash or the material obtained from step (1) with different additives, either simultaneously or sequentially.

Contacting in step (2) may take place for a time period of no less than 10 minutes and/or of no more than 12 hours. Contact time between 15 minutes and 1 hour is generally suitable.

Contacting in step (2) may take place at a temperature of less than 100° C. A temperature greater than 0° C. and less than 100° C., or from 10° C. to about 70° C., preferably from 15° C. to about 50° C. A temperature between 4 and 45° C., more preferably between 10 and 30° C., would be suitable for this contacting step.

In preferred embodiments, step (2) excludes a phosphatation and/or a sulfidation.

In alternate embodiments, the method may further include a phosphatation by using a phosphate-containing compound as a further additive. The phosphatation may be carried out at the same time as during contacting in step (2). The phosphatation and the contacting in step (2) may be carried out sequentially.

In other embodiments, the method may further include a sulfidation by using a sulfide-containing compound (e.g., Na₂S) as a further additive component. The sulfidation may be carried out at the same time as during contacting in step (2). The sulfidation and the contacting in step (2) may be carried out sequentially.

In a particularly preferred embodiment of the present method, in which the additive comprises sodium silicate, the method may include diluting a concentrated sodium silicate solution (generally containing from 30 to 40 wt % sodium silicate) with either water or an acidic aqueous solution to achieve a sodium silicate content of from 1 to 10 wt %, preferably from 2 to 5 wt % in the diluted solution; optionally adding another additive component (such as ferric sulfate, ferric chloride, strontium chloride, dolomitic lime or combinations thereof) to this diluted sodium silicate solution; spraying or misting the diluted sodium silicate solution onto a mass of coal fly ash with is either motionless (such as in a heap or pile or spread on a liner) or which is moving (such as on a conveyor belt), the amount of the diluted additive solution being sufficient to not exceed the liquid holding capacity of fly ash, and preferably to approach within 5%, preferably within 3% of the value for the liquid holding capacity or even more preferably to reach the liquid holding capacity of the fly ash. The sprayed or misted fly ash may be collected to be placed in a container or moved such as to landfill or a clinker process for re-use. In some embodiments, the diluted sodium silicate solution applied to the fly ash may have a temperature from 10° C. to about 70° C., preferably from 15° C. to about 50° C. The diluted sodium silicate solution may be pre-heated before contacting the fly ash. Alternatively, the water or acidic solution used to dilute the concentrated sodium silicate solution may have a temperature already within the preferred temperature range provided above, or may be pre-heated before dilution.

### Step (3): Drying

In some embodiments of the present invention, the method further comprising: (3) drying the material obtained after contacting with the at least one additive. Drying in step (3) may be carried out at a temperature of more than 100° C. and/or less than 150° C. The objective of the drying step (3) is to remove the water from the material which is resulting from the contacting step (2). The water removed in step (3) is free water, and the mechanism for water removal during drying is evaporation.

Before carrying out the drying in step (3), the material obtained after performing the contacting in steps (1) and (2) may be optionally formed into shapes, for example extruded or molded into one or more forms such as in the form of pellets, granules, bricks, briquettes, or the like.

Drying time will vary depending on the amount of water used during step (2). Drying time is typically at least 5 minutes, preferably at least 30 minutes, and at most 12 hours. A drying time between 20 minutes and 6 hours is suitable when the water content in the material obtained in step (2) is between 20 and 40 wt %. A drying time between 30 minutes and 3 hours is preferred.

Drying preferably takes place in air, but may take place under an inert (non-reactive) atmosphere such as nitrogen.

Drying may be indirect drying in which a heat transfer fluid having a temperature greater than the material to be dried is heating a surface and the material to be dried is then dried by contact with the heated surface (but without being in contact with the heat transfer fluid).

Drying may be direct drying in which a fluid having a temperature greater than the material to be dried (such as hot air) is brought in contact with the material to be dried.

Drying may take place at atmospheric pressure or under vacuum to facilitate the removal of water from the material to be dried.

The drying in step (3) is preferably carried out without calcining or sintering the contacted material resulting after performing steps (1) and (2). In particular, drying excludes heating the material resulting after performing steps (1) and (2) at a temperature exceeding 500° C. Preferably, drying in step (3) should not comprise conditions which favor the volatilization of heavy metals (such as Se and/or As) contained in the contacted material resulting after performing steps (1) and (2).

The dried matter may contain less than 50% of leachable heavy metal (such as selenium and/or arsenic) than the initial coal fly ash before the treatment in step (2) with the additive.

The dried matter resulting from step (3) preferably contains 1 ppm or less of leachable Se.

In some embodiments, the method may comprise successive contacting steps (2ₙ) with optionally one or more drying or partial drying steps (3′) carried out between contacting steps (2ₙ), and a final drying step (3). The additive(s) used in the contacting steps (2ₙ) may be the same additive applied in several portions or may be different additives. The successive contacting steps (2ₙ) may employ the same contacting technique; or different contacting techniques may be used in successive contacting steps (2ₙ). At least one of the successive contacting steps (aₙ) uses an additive comprising a water-soluble source of silicate.

In some particular embodiments in which two or more additives are contacted with the fly ash in separate contacting steps (2ₙ), the method may comprise:

(2i) contacting the fly ash with a first additive in the presence of water,
(3′) optionally drying the contacted material resulting from step (2i) to form a first partially-dried or dried matter;
(2ii) contacting the contacted fly ash resulting from step (2i) or the partially-dried/dried matter formed in optional step (3′) with a second additive optionally in the presence of additional water;
(3) drying the material resulting from step (2ii) to form a final dried matter;

wherein the first and second additives are different, wherein each additive may comprise at least one strontium-containing compound; at least one barium-containing compound; dolomite; one or more dolomite derivatives (such as, dolomitic lime, selectively calcined dolomite, and/or hydrated dolomite); at least one iron-containing compound; at least one water-soluble source of silicate; or any combinations or two or more thereof.

The techniques for contacting in steps (2i) and (2ii) may be the same or different. The optional additional water in step (2ii) may be in the form of pure water or an aqueous medium (e.g., an acidic solution).

In some alternate embodiments in which the same additive is contacted with the fly ash using more than one contacting step (2), the method may comprise:

(2i′) contacting the fly ash with a first portion of an additive in the presence of water,
(3′) optionally drying the material resulting from step (2i′) to form a partially-dried or dried matter;
(2ii′) contacting the contacted sodic fly ash resulting from step (2i′) or the partially-dried/dried matter formed in optional step (3′) with a second portion of the same additive optionally in the presence of additional water;
(3) drying the material resulting from step (2ii′) to form a final dried matter;

wherein the additive comprises at least one strontium-containing compound; at least one barium-containing compound; dolomite; one or more dolomite derivatives (such as, dolomitic lime, selectively calcined dolomite, and/or hydrated dolomite); at least one iron-containing compound (such as ferric sulfate or chloride); a water-soluble source of silicate; or any combinations or two or more thereof; and

wherein the contacting steps (2i′) and (2ii′) may use the same contacting technique or different contacting techniques.

The optional additional water in step (2ii′) may be in the form of pure water or an aqueous medium (e.g., an acidic solution).

A yet alternate embodiment of the present invention relates to a method for treating a sodic fly ash to form a treated material which is suitable for landfill or valorization.

Such embodiment of the method preferably includes the contacting step (2) in the presence of water with at least one additive as previously described. The contacting step is preferably carried out in the presence of water, but the contacted mass of sodic fly ash is still in ‘dry’ state and the amount of water used does not typically exceed the water holding capacity of the sodic fly ash. The contacting is preferably carried out with a water amount not to exceed the water holding capacity of the sodic fly ash, and preferably sufficient to be within +1-5% of the water holding capacity of the sodic fly ash. The additive used for the heavy metal stabilization preferably comprises a water-soluble source of silicate and optionally at least one other additive component as previously described. The additive is added in an amount sufficient to stabilize at least one heavy metal initially present in the sodic fly ash before treatment. The resulting material obtained from such stabilization step has a much reduced leachability of this heavy metal compared to the sodic fly ash before the treatment with the additive.

Because the stabilization of the heavy metal is expected to be carried out primarily by converting at least a portion of the heavy metal into a water-insoluble form, the method may further comprise: washing the treated fly ash—preferably obtained after both steps (1) and (2)—with a washing medium (e.g., water or an aqueous medium) so as to dissolve most of the water-soluble fraction of the treated sodic fly ash. Because water is used in such washing step, it is recommended not to dry the material obtained after steps (1) and (2) before washing. As such, in this particular embodiment, such method omits the drying step (3).

The water-soluble fraction in a sodic fly ash may comprise up to 60 wt % of the sodic fly ash. Typical ranges of water-soluble content in sodic fly ashes may be from about 5 wt % up to about 50 wt % based on the total weight of the sodic fly ash. The soluble fraction of the treated sodic fly ash should comprise primarily water-soluble sodium salts. ‘Spent sorbent’ generally refers to the reaction mixture obtained in a dry sodium-based injection and this spent sorbent is collected in the fly ash material. This spent sorbent contains reaction products and byproducts (such as highly water-soluble sodium sulfate, sodium sulfite, sometimes sodium bisulfate), and also unconverted sodium-based sorbent such as sodium bicarbonate and/or sodium carbonate. At least 50%, or at least 60%, or at least 70%, of the water soluble fraction of the treated sodic fly ash is dissolved in the subsequent washing step by dissolution into the washing medium (water or acidic medium).

By treating the sodic fly ash with anhydrite to reduce the Na₂O content and to also lower the pH of the sodic fly ash, by treating with the additive to stabilize some heavy metals contained herein by insolubilization and then finally dissolving at least a portion of the soluble sodium-based compounds from this stabilized material, the end (treated and washed) material obtained by this two-step treatment would have a reduced heavy metal leachability (especially for Se and/or As) and a reduced Na₂O content. If this end material does not exceed the environment regulatory levels for heavy metals, then the treated and washed material may be suitable for landfilling. And if this end material further does not exceed the maximum content of Na₂O (generally maximum of 1.5 wt % of combined Na₂O+K₂O) according to ASTM C 618, then this end material may be valorized, for example in cement and concrete manufacturing.

A particular embodiment of the method according to the present invention provides for the use of a slurry of anhydrite in a dilute sodium silicate solution (of about 5.0%) to obtain a mixture containing about 5% anhydrite in sodium silicate solution. This mixture is contacting with the coal fly ash, particularly with the sodic fly ash for carrying out the simultaneous contacting steps (1) and (2). It is expected that such mixture of anhydrite slurry and sodium silicate strongly binds to coal fly ash upon hydrolysis of sodium silicate, while the anhydrite provides a pozzolan matrix and simultaneously reduces the overall sodium content of the treated coal fly ash.

The present invention having been generally described, the following Examples are given as particular embodiments of the invention and to demonstrate the practice and advantages thereof. It is understood that the examples are given by way of illustration and are not intended to limit the specification or the claims to follow in any manner.

### EXAMPLES

### Example 1: Determination of Se content in various sodic fly ashes

Three sodic fly ashes A, B, C from coal fired plants using a dry sorbent injection system employing sodium bicarbonate or trona for acid gas mitigation were analyzed for contents in sodium-containing compounds and in Se. The results are shown in TABLE 1.

Main insoluble elements expressed under their oxide form, were silica, alumina, iron oxide, and calcium oxide. These main elements represented from 82 to 93% of the water-insoluble portion of the fly ashes.

The sodic fly ashes A and B contained between 1.5 wt % and 3.5 wt % of Na₂O. Even if these values were low, they were equal to or exceeded standard specifications for pozzolans from fly ash (ASTM-C-618: maximum available alkalis: [Na₂O]=1.5 wt %), and neither sodic fly ashes A and B could be valorized in the concrete industry.

The fly ash sample C contained a high amount of water-soluble material, about 32 wt %, ([Na₂O]=16.6 wt %) and could not be valorized into concrete.

TABLE 1

| | | Sodic | Sodic | Sodic |
|---|---|---|---|---|
| | Unit | Fly Ash A | Fly Ash B | Fly Ash C |
| Sorbent used in | — | trona | Sodium | trona |
| DSI system | | | bicarbonate | |
| Water-soluble | g/kg fly ash | 69 | 33 | 324 |
| Fraction | | | | |
| Na₂SO₄ | g/kg fly ash | 37 | 25 | 135 |
| Na₂CO₃ | g/kg fly ash | 33 | 7 | 180 |
| NaHCO₃ | g/kg fly ash | 0 | 1 | 5 |
| Expressed as | wt % | 3.5 | 1.5 | 16.6 |
| Na₂O | | | | |
| Water-insoluble | g/kg fly ash | 931 | 967 | 676 |
| Fraction | | | | |
| SiO₂ | g/kg insolubles | 520 | 480 | 471 |
| Al₂O₃ | g/kg insolubles | 220 | 190 | 265 |
| CaO | g/kg insolubles | 130 | 110 | 21 |
| Fe₂O₃ | g/kg insolubles | 59 | 52 | 70 |
| Se* | mg/kg fly ash | 4.5 | 2.6 | 15.5 |

*measured by Atomic Absorption

### Example 2: Leaching Tests with sodic fly ashes without treatment with additive

Two types of leaching tests were performed for the sodic fly ashes A, B, C of Example 1.

Sodic fly ashes A and B were leached according to European Standard NF-EN-12457-2 in which leaching was carried out with demineralized water with a Liquid to Solid ratio L/S=10 mL water/g solid during 24 hours (using 90 grams of fly ash and 900 grams of demineralized water).

Results are shown in TABLE 2. Without treatment according to the present invention, Se leaching from these fly ashes was high (57-101%) at a high alkaline pH of about 12. On the other end, As leaching from these fly ashes was moderate (34%) to very low (2%) at a high alkaline pH of about 12.

### European Standard NF EN 12457-2 Leaching Test: Summarized Protocol

1. 95% of the solid must pass through a 4 mm (0.4 mesh) sieve; if more than 5% does not pass, the fraction above 4 mm must be crushed in a jaw crusher;
2. Prepare the mixture fly ash with demineralized water:
   a. ‘m’ fly ash corresponding to ‘m’ dry solid=0.090+/−0.005 kg
   b. L/S ratio=10 L leaching agent/kg dry solid+/−2%;
3. Mix during 24+/−0.5 hours in a rotating vessel at 5-10 turns/min and T=20+/−5° C.;
4. At the end of the leaching, extract the content of the rotating vessel;
5. Leave it settle during 15+/−5 min;
6. Filtrate on a membrane filter 0.45 μm under vacuum (−300 to-700 mbar) or under pressure (<5 bar) and measure the eluate volume, the conductivity, temperature, pH, and redox potential;
7. Analyze the content of the eluate;
8. In parallel, make a “blank trial”, with 0.95 L of leaching agent without any solid and follow the previous operating protocol. Analyze the content of the blank eluate.

Sodic fly ashes A, B and C were leached according to the U.S. Standard Method EPA 1311 from EPA Manual SW 486: TCLP (Toxicity Characteristic Leaching Procedure) in which leaching was carried out with an acetic acid solution with a Liquid to Solid ratio L/S=20 g water/g solid during 18 hours (using 50 grams of fly ash and 1000 grams of diluted acetic acid solution of pH=2.88). Results for TCLP leaching tests are shown in TABLE 3.

TABLE 2

| | | Sodic | Sodic |
|---|---|---|---|
| | Unit | Fly Ash A | Fly Ash B |
| Sorbent used in DSI | — | trona | Sodium |
| system | | | bicarbonate |
| pH at end of leaching | | 12.3 | 11.9 |
| test | | | |

SELENIUM

| | | | |
|---|---|---|---|
| Se* in fly ash | mg/kg fly ash | 4.5 | 2.6 |
| Solubilized Se from | mg/kg fly ash | 4.6 | 1.5 |
| fly ash | | | |
| % solubilized Se | % | 101% | 57% |
| compared to initial Se | | | |

ARSENIC

| | | | |
|---|---|---|---|
| As* in fly ash | mg/kg fly ash | 29.1 | 28.2 |
| Solubilized As from | mg/kg fly ash | 10.1 | 0.5 |
| fly ash | | | |
| % solubilized As | % | 34% | 2% |
| compared to initial As | | | |

*measured by Atomic Absorption Spectroscopy

American standard: method EPA 1311 from EPA Manual SW 4861: TCLP (Toxicity Characteristic Leaching Procedure):
1. Pass the solid through a 10 mm (1.4 mesh) sieve; if necessary, reduce the granulometry of the solid by grinding or de-agglomeration;
2. Determine the leaching agent No. 1 or 2 to be used:
   Leaching agent 1: in a 1-L volumetric flask, add 500 mL water+5.7 mL glacial acetic acid+64.3 mL NaOH 1 mol/L and adjust the level with water
   Leaching agent 2: in a 1-L volumetric flask, add 5.7 mL glacial acetic acid (pure, water free) and adjust the level with water
a. Add 5.0 g of solid into 96.5 mL water in a 500-mL Erlenmeyer flask; stir with a magnetic stirrer during 5 min.;
b. Measure the pH:
i. If pH<5.0, use the leaching agent No. 1 (pH=4.93)
ii. If pH>5.0: add 3.5 mL HCl 1 mol/L, stir briefly, heat up at 50° C. and maintain the heating 10 min., then leave to cool down, and measure the pH:
1. If pH<5.0, use the leaching agent 1 (pH=4.93)
2. If pH>5.0, use the leaching agent 2 (pH=2.88)
3. Weigh 100+/−0.1 g of sample and put it into the rotating vessel;
4. Slowly add the leaching agent so as to reach a Liquid to Solid ratio of 20 g/g solid sample;
5. Close the vessel, fix it on a twin-shell blender;
6. Run the leaching at a speed of 30+/−2 turns/min during 18+/−2 hours at a temperature of 23+/−2° C.;
7. If the solid sample contain carbonates, the vessel can be open periodically to evacuate the overpressure;
8. After the test, filtrate on a 0.6-0.8 μm filter and measure the pH of the filtrate;
9. Divide the leachates for further analyses and conservation (T<4° C.);
10. For the analysis of metals, acidify the leachates at pH<2 with HNO₃ 1 mol/L;
11. Analyze the content of the eluate;
12. In parallel, after 20 leaching tests, make a “blank trial” without any solid and follow the previous operating protocol. Analyze the content of the blank eluate.
13. Between the sampling of the solid and the final analysis of the leachates, the duration must not exceed 28 days for volatile compounds, 61 days for semi-volatile compounds, 56 days for mercury, and 360 days for other metals.

TABLE 3

| | | Sodic | Sodic | Sodic |
|---|---|---|---|---|
| | Unit | Fly Ash A | Fly Ash B | Fly Ash C |
| Sorbent used in DSI | — | trona | Sodium | trona |
| system | | | bicarbonate | |
| pH at end of leaching | | 5.9 | 5.2 | 5.9 |
| test | | | | |

SELENIUM

| | | | | |
|---|---|---|---|---|
| Se* in fly ash | mg/kg fly ash | 4.5 | 2.6 | 15.5 |
| Solubilized Se from | mg/kg fly ash | 0.14 | 0.2 | 14.6 |
| fly ash | | | | |
| % solubilized Se | % | 3% | 8% | 94% |
| compared to initial Se | | | | |

ARSENIC

| | | | | |
|---|---|---|---|---|
| As* in fly ash | mg/kg fly ash | 29.1 | 28.2 | 47 |
| Solubilized As from | mg/kg fly ash | <0.2 | 0.4 | 13.9 |
| fly ash | | | | |
| % solubilized As | % | <1 | ca. 1 | 30 |
| compared to initial As | | | | |

*measured by Atomic Absorption Spectroscopy

Without treatment with an additive according to the present invention, Se leaching under TCLP conditions from the fly ash C was high (94%) and As leaching under TCLP conditions from the fly ash C was moderate (30%). However almost no or little leaching was observed for Se and As under TCLP conditions for sodic fly ashes A and B.

The significance difference in Se leachability between sodic fly ashes A & B and sodic fly ash C may be explained by the presence of different selenium species in these sodic fly ashes. TCLP test on fly ash C showed a higher percentage of solubilization than fly ashes A and B; it may be due to a different pathway of capture of Se in flue gases. For fly ashes A and B, Se in coal is oxidized into gaseous SeO₂ which is adsorbed as Se^{+IV} on the surface of small fly ashes particles. Further chemical reactions occur to chemically bind selenite species; when pH>8, HSeO₃⁻ SeO₃²⁻ (pKₐ=8.3) dianions are formed and the electrostatic repulsion between anionic species and anionic surface may cause the deadsorption of the oxyanions into the leachate. The remaining SeO₂ (gaseous or solid) would have exited at the coal-fired plant stack.

For sodic fly ash C, part of SeO₂ may have been trapped onto fly ashes surface; but while some SeO₂ may have gone out at coal plant stack, the main portion may have been neutralized by calcined trona into sodium selenates, as Se^{+vi} (neutralization of Se species with Na₂CO₃ from trona would result in reaction of acidic SeO₂, H₂SeO₃, or H₂SeO₄ to form for example Na₂SeO₄₍ₛ₎.

Sodium selenate (Se oxidation number+VI) obtained by neutralization with a sodium sorbent would be more soluble in acidic condition than the complex —FeHₓSeO₃^{x-1} (Se oxidation number+IV) which would be obtained between gaseous SeO₂ and fly ash surface. This may explain why sodic fly ash C showed higher Se leachability at a pH of 5.9, while the other two fly ashes did not.

### Example 3: Treatment with various additives to Reduce Se leachability

Determination of Liquid Holding Capacity of a Sodic Fly Ash D: The liquid holding capacity of a sodic fly ash D was measured by adding water to 20 grams of fly ash until it formed a soft malleable paste. This was found to be equivalent to 34.2% by weight of fly ash D.

Treatment: One additive was either dissolved or dispersed in 6.5 grams of deionized water. More than one additive may be dissolved or dispersed in the deionized water. This slurry or suspension was then added to 19 grams of fly ash. The resulting paste was stirred as much as possible with a spatula and allowed to dry at 110° C. for 2 hours.

The additives used in Example 3 were strontium chloride, strontium hydroxide, sodium silicate, dolomitic lime pulverized (DLP), combination of DLP and sodium silicate, and combination of strontium chloride and sodium silicate.

The sodium silicate solution (40-42 degree Baume) was obtained from Aqua Solutions (Deer Park, Tex.).

The dolomitic lime pulverized with ca. 4-micron sized particles was from Grupo Calider, Monterrey, Mexico.

To prepare the strontium chloride additive, 0.93 g (or 0.37 g) of strontium carbonate (Solvay CPC Barium Strontium Monterrey standard grade) using 0.6 g (or 0.24 g) concentrated HCl were diluted to 6.5 g with deionized water. A portion of this solution was added to 19 g of fly ash to reach a content of 5 wt % (or 2 wt %) SrCl₂.

Strontium Hydroxide was supplied by Solvay CPC Barium Strontium, Monterrey. In addition, to freshly prepare the strontium hydroxide additive, strontium sulfide (SrS) was mixed with sodium hydroxide, and a selective precipitation of strontium hydroxide took place which allowed the recovery of strontium hydroxide from sodium sulfide (Na₂S). The obtained strontium hydroxide was then diluted with water to add to a fly ash sample to be treated.

Extraction (leaching test): 18 grams of the resulting dried treated material was dispersed in 100 grams of deionized water or diluted hydrochloric acid solution (7 g HCl in 93 g water) of a pH of about 3.5. The resulting slurry was stirred with a magnetic stirrer for 10 minutes. The slurry was filtered with a syringe filter using 0.1-micron Whatman membrane filter. This clear extract was used directly for selenium analysis. The results on the reduction of Se leachability using the treatment method according to the present invention can be found in TABLE 4.

TABLE 4

| | wt | | Se** (ppm) | % reduction in |
|---|---|---|---|---|
| Additive(s) | % | Extraction | extracted | Se leachability |
| — | — | Water* | 3.1 | — |
| — | — | Acidic water | 2.3 | 26.1 |
| Sr(OH)₂ | 5% | Acidic water | 1.6 | 49 |
| Sodium silicate | 5% | Acidic water | 0.54 | 83 |
| Dolomitic Lime | 5% | Acidic water | 0.46 | 86 |
| Pulverized (DLP) | | | | |
| Sr(OH)₂ + | 2% | Acidic water | 0.43 | 87 |
| Sodium silicate | 2% | | | |
| DLP + | 2% | Acidic water | 0.03 | 100 |
| Sodium silicate | 2% | | | |
| Sodium silicate | 2% | Acidic water | 0.03 | 100 |
| SrCl₂ | 5% | Acidic water | 0.03 | 100 |
| SrCl₂ + | 2% | Acidic water | 0.03 | 100 |
| Sodium Silicate | 2% | | | |

* = measured 0.03 ppm Se in extraction water
**measured by ICP

### Example 4: Treatment with concentrated sodium silicate solution to reduce Se, As Leachability

Two sodic fly ash samples E and F were obtained by injecting trona in a flue gas generated by combustion of a Permian coal (sub-bitumous). The sodic fly ash E had about 12 wt % of spent sorbent (water-soluble sodium salts), whereas the sodic fly ash F had about 21 wt % of spent sorbent.

A control fly ash Z was also obtained with the same Permian coal but without injecting trona in a flue gas.

Treatment: a sodium silicate solution of 40 wt % was applied to a mass of sodic fly ash E or control fly ash Z. The water added for the contacting step was the water present in the solution of sodium silicate. After 10 to 15 minutes of contact, the contacted mass was allowed to dry. The amounts used in the treatment step according to an embodiment of the present invention can be found in TABLE 5.

TABLE 5

| | | | Sodium | | Water | | |
|---|---|---|---|---|---|---|---|
| | | | silicate | | added | | |
| | | | solution | Sodium | [from | Sodium | Water |
| | Fly ash | fly ash | 40% A.I. | silicate | solution] | silicate | added |
| Ex. | sample | (g) | (g) | used (g) | (g) | (wt %*) | (wt %*) |
| 4a | Z | 100 | — | | | 0 | 0 |
| | (control) | | | | | | |
| 4b | Z | 98 | 2 | 0.8 | 1.2 | 0.8% | 1.2% |
| | (control) | | | | | | |
| 4c | Z | 95 | 5 | 2 | 3 | 2% | 3% |
| | (control) | | | | | | |
| 4d | E | 100 | — | | | 0 | 0 |
| 4e | E | 98 | 2 | 0.8 | 1.2 | 0.8% | 1.2% |
| 4f | E | 95 | 5 | 2 | 3 | 2% | 3% |
| 4g | F | 100 | — | | | 0 | 0 |
| 4h | F | 95 | 5 | 2 | 3 | 2% | 3% |

*based on total weight of fly ash + sodium silicate + water

The results on the reduction of Se and As leachability using the treatment method according to this embodiment of the present invention can be found in TABLE 6. As and Se leachability were analyzed according to the TCLP method (Toxicity Characteristic Leaching Procedure) using an inductive couple plasma analyzer.

For the control fly ash Z (non-sodic fly ash), it was observed that the leachability of Se and As was increased with the addition of a concentrated sodium silicate solution and a total water content of 1.2 and 3 wt %. This increase in leachability was indeed quite significant for selenium in the control fly ash sample.

For the sodic fly ashes E and F, it was observed that the leachability of Se and As was decreased with the addition of a concentrated sodium silicate solution. The effect was more pronounced with arsenic than for selenium. However the leachate level of Se was already quite low at about 0.29 and 0.3 ppm (see untreated samples 4d and 4g). So it is believed that the beneficial effect of sodium silicate solution depends on the initial levels of the leachable heavy metals. For leachate levels of 0.3 ppm or less, the beneficial effects of such treatment may not be as good as with higher leachate levels.

On the other end, the leachability of As content was reduced from 1.1 ppm in the leachates of untreated samples 4d and 4g (without sodium silicate addition) by 22% to 73% in the leachates of treated samples (4e, 4f, 4h).

TABLE 6

| | | | Sodium | | | | | | |
|---|---|---|---|---|---|---|---|---|---|
| | | | silicate | | | | % change | | % change |
| | Fly | fly | solution | Sodium | Water | | in leach- | | in leach- |
| | ash | ash | 40% | silicate | added | Se | ability | As | ability |
| Ex. | sample | (g) | A.I. (g) | (wt %*) | (wt %*) | (ppm) | for As | (ppm) | for As |
| 4a | Z | 100 | — | — | — | 0.066 | | 0.021 | |
| | (control) | | | | | | | | |
| 4b | Z | 98 | 2 | 0.8% | 1.2% | 0.085 | 28.8 | 0.068 | 223.8 |
| | (control) | | | | | | | | |
| 4c | Z | 95 | 5 | 2% | 3% | 0.062 | −6.1 | 0.053 | 152.4 |
| | (control) | | | | | | | | |
| 4d | E | 100 | — | — | — | 0.290 | | 1.100 | |
| 4e | E | 98 | 2 | 0.8% | 1.2% | 0.270 | −6.9 | 0.850 | −22.7 |
| 4f | E | 95 | 5 | 2% | 3% | 0.260 | −10.3 | 0.470 | −57.3 |
| 4g | F | 100 | — | — | — | 0.300 | | 1.100 | |
| 4h | F | 95 | 5 | 2% | 3% | 0.270 | −10.0 | 0.360 | −67.3 |

*based on total weight of fly ash + sodium silicate + water

### Example 5: Treatment with diluted sodium silicate solution to reduce Se, as leachability

The same two sodic fly ash samples E and F used in Example 4 were used in Example 5.

Treatment: a sodium silicate solution of 40 wt % was first diluted with water to achieve a total water content of 13 wt % based on the total weight of the fly ash+sodium silicate solution+water mixture. The total amount of water used for the contacting step was the water present in the solution of sodium silicate and the additional water used to dilute the sodium silicate solution. After 10 to 15 minutes of contact, the contacted mass was allowed to dry. The amounts used in the treatment step according to this embodiment of the present invention can be found in TABLE 7.

The results on the reduction of Se and As leachability using the treatment method according to this embodiment of the present invention can be found in TABLE 8. As and Se leachability were analyzed according to the TCLP method (Toxicity Characteristic Leaching Procedure) using an inductive couple plasma analyzer.

TABLE 7

| | | | Sodium | | | | | |
|---|---|---|---|---|---|---|---|---|
| | | Wt. | silicate | | Water | addi- | | water |
| | | of | solution | Sodium | [from | tional | sodium | content |
| | Fly ash | Coal | 40% | Silicate | solution] | water | silicate | (wt |
| Ex. | sample | (g) | A.I. (g) | (g) | (g) | (g) | (wt %*) | %*) |
| 5a | E | 100 | 0 | 0 | 0 | 15 | 0% | 13% |
| 5b | E | 99 | 1 | 0.4 | 0.6 | 14.4 | 0.35% | 13% |
| 5c | E | 98 | 2 | 0.8 | 1.2 | 13.8 | 0.71% | 13% |
| 5d | E | 95 | 5 | 2 | 3 | 12 | 1.77% | 13% |
| 5e | E | 90 | 10 | 4 | 6 | 9 | 3.54% | 13% |
| 5f | F | 100 | 0 | 0 | 0 | 15 | 0% | 13% |
| 5g | F | 95 | 5 | 2 | 3 | 12 | 1.77% | 13% |
| 5h | F | 90 | 10 | 4 | 6 | 9 | 3.54% | 13% |

*based on total weight of fly ash + sodium silicate + water

TABLE 8

| | | | | | | | % | | % |
|---|---|---|---|---|---|---|---|---|---|
| | | | Sodium | | | | change | | change |
| | | Wt. | silicate | | | | in | | in |
| | Fly | of | solution | sodium | water | | leach- | | leach- |
| | ash | Coal | 40% | silicate | content | Se | ability | As | ability |
| Ex. | sample | (g) | A.I. (g) | (wt %*) | (wt %*) | (ppm) | for Se | (ppm) | for As |
| 5a | E | 100 | 0 | 0% | 13% | 0.32 | | 1.2 | |
| 5b | E | 99 | 1 | 0.35% | 13% | 0.31 | −3.1 | 0.67 | −44.2 |
| 5c | E | 98 | 2 | 0.71% | 13% | 0.29 | −9.4 | 0.47 | −60.8 |
| 5d | E | 95 | 5 | 1.77% | 13% | 0.3 | −6.3 | 0.34 | −71.7 |
| 5e | E | 90 | 10 | 3.54% | 13% | 0.2 | −37.5 | 0.25 | −79.2 |
| 5f | F | 100 | 0 | 0% | 13% | 0.3 | | 1 | |
| 5g | F | 95 | 5 | 1.77% | 13% | 0.3 | 0.0 | 0.26 | −74.0 |
| 5h | F | 90 | 10 | 3.54% | 13% | 0.26 | −13.3 | 0.21 | −79.0 |

*based on total weight of fly ash + sodium silicate + water

For the sodic fly ashes E and F, it was observed that the leachability of Se and As was decreased with the addition of a dilute sodium silicate solution. The reduction The effect was again more pronounced with arsenic than for selenium. However the leachate level of Se was already quite low at about 0.30 and 0.32 ppm (see untreated samples 5a and 5f). So it is believed that the beneficial effect of sodium silicate solution depends on the initial levels of the leachable heavy metals.

On the other end, the leachability of As was reduced from 1 or 1.2 ppm in the leachates of untreated samples 5a and 5f (without sodium silicate addition) by 44% to 79% in the leachates of treated samples (5b-e, 5g).

The disclosure of all patent applications, and publications cited herein are hereby incorporated by reference, to the extent that they provide exemplary, procedural or other details supplementary to those set forth herein. Should the disclosure of any of the patents, patent applications, and publications that are incorporated herein by reference conflict with the present specification to the extent that it might render a term unclear, the present specification shall take precedence.

Each and every claim is incorporated into the specification as an embodiment of the present invention. Thus, the claims are a further description and are an addition to the preferred embodiments of the present invention.

While preferred embodiments of this invention have been shown and described, modifications thereof can be made by one skilled in the art without departing from the spirit or teaching of this invention. The embodiments described herein are exemplary only and are not limiting. Many variations and modifications of systems and methods are possible and are within the scope of the invention.

Accordingly, the scope of protection is not limited by the description and Examples set out above, but is only limited by the claims which follow, that scope including all equivalents of the subject matter of the claims.

What is claimed is:

1. A treatment method for a coal fly ash, wherein the coal fly ash is provided by a combustion process in which a sodium-containing sorbent is injected into a flue gas generated during coal combustion to remove at least a portion of pollutants contained in the flue gas, said treatment method comprising:
1) contacting the coal fly ash with anhydrite; and
2) contacting the coal fly ash in the presence of water with at least one additive comprising sodium silicate, potassium silicate, or any combination thereof,
wherein said coal fly ash is a sodic fly ash with a Na content greater than 1.5 wt % expressed as Na₂O.

2. (canceled)

3. (canceled)

4. The method according to claim 1, wherein said at least one additive further comprises at least one component selected from the group consisting of strontium hydroxide, strontium chloride, dolomite, dolomitic lime, ferric sulfate, ferric chloride, and any combinations of two or more thereof.

5. The method according to claim 1,
wherein said at least one additive used in step (2) comprises a combination of sodium silicate with at least one other component selected from the group consisting of strontium hydroxide, strontium chloride, dolomitic lime, ferric sulfate, and ferric chloride.

6. The method according to claim 1, wherein said coal fly ash is a sodic fly ash with a Na content of less than 50 wt % expressed as Na₂O.

7. The method according to claim 1, wherein the contacting steps (1) and (2) are carried out simultaneously.

8. The method according to claim 1, wherein the contacting step (1) is carried out before the contacting step (2).

9. The method according to claim 1, wherein the contacting in step (1) comprises dry mixing the anhydrite with said coal fly ash.

10. The method according to claim 9, wherein the contacting in step (2) comprises applying the at least one additive and the water onto the contacted material obtained in step (1).

11. The method according to claim 1, further comprising: before performing step (2), dispersing or dissolving or diluting the at least one additive into water or an acidic solution to form an aqueous suspension, slurry or solution containing the at least one additive, and then carrying out the contacting of said coal fly ash with said resulting aqueous dispersion, slurry, or solution in step (2).

12. The method according to claim 1, wherein contacting in step (2) comprises spraying or misting an aqueous solution containing the at least one additive onto said coal fly ash.

13. The method according to claim 12, wherein said spraying or misting further reduces dusting of said coal fly ash.

14. The method according to claim 1, further comprising: before performing step (2), first dry mixing the at least one additive in solid form and said coal fly ash to form a dry blend, wherein the contacting in step (2) comprises adding water or an acidic solution to said dry blend.

15. The method according to claim 1, wherein contacting in step (2) uses a water content so as to form a paste comprising the at least one additive and said sodic fly ash, and wherein the paste contains at most 40 wt % water.

16. The method according to claim 1, wherein contacting in step (2) is carried out under an acidic pH of from 3 to 7 or under near-neutral pH of from 6 to 8.

17. The method according to claim 1, further comprising:
(3) drying the material obtained after both contacting steps (1) and (2) at a temperature equal to or more than 100° C.

18. The method according to claim 17, wherein the drying in step (3) is carried out without calcining or sintering the material obtained after both contacting steps (1) and (2).

19. The method according to claim 1, wherein the coal fly ash comprises a heavy metal to be stabilized, and wherein the method reduces leachability of such heavy metal by at least 50%.

20. The method according to claim 19, wherein the heavy metal to be stabilized is selected from the group consisting of selenium, arsenic, and combination thereof.

21. The method according to claim 1, wherein said at least one water-soluble source of silicate comprises sodium silicate, and wherein the method further comprises: diluting a concentrated sodium silicate solution with water or an acidic aqueous medium to form a diluted solution, and then spraying or misting the resulting diluted solution onto a mass of said coal fly ash for contact between sodium silicate and said coal fly ash.
